(19) United States
(12) Patent Application Publication
(10) Pub. No.: US 2015/0185731 A1
(43) Pub. Date: Jul. 2, 2015

(54) WORK-IN-PROCESS INSPECTION SYSTEM USING MOTION DETECTION, AND METHOD THEREOF

(71) Applicant: Hyundai Motor Company, Seoul (KR)

(72) Inventors: Se-Hoon Ham, Ulsan (KR); Dong-Ho Kwak, Ulsan (KR); Suyoung Kim, Ulsan (KR); Kwang Joon Lee, Daegu (KR); Yong Tae Kim, Ulsan (KR)

(73) Assignee: HYUNDAI MOTOR COMPANY, Seoul (KR)

(21) Appl. No.: 14/559,547

(22) Filed: Dec. 3, 2014

(30) Foreign Application Priority Data
Dec. 26, 2013 (KR) 10-2013-0163782
Jun. 17, 2014 (KR) 10-2014-0073686

(51) Int. Cl. G05B 19/418

(52) U.S. Cl. CPC G05B 19/41875

(57) ABSTRACT

A work-in-process inspection system is provided and includes a moving image imaging unit that captures a working motion of a worker and an imaging device that captures an image of a vehicle part that is operated on by a worker. A controller determines a difference between the working motion of the worker captured by the moving image imaging device and a predetermined reference motion, and determines a difference between the image captured by the imaging device and a predetermined reference image. Accordingly, whether a predetermined working process has been performed is determined by comparing an image captured through a 3D scanner to a reference motion.

### CROSS-REFERENCE TO RELATED APPLICATION(S)

Pursuant to 35 U.S.C. §119(a), this application claims the benefit of Korean Patent Application No. 10-2013-0163782 filed in the Korean Intellectual Property Office on Dec. 26, 2013 and No. 10-2014-0073686 filed in the Korean Intellectual Property Office on Jun. 17, 2014, the entire contents of which are incorporated herein by reference.

### BACKGROUND

1. Field of the Invention

The present invention relates to a work-in-process inspection system using motion detection. More particularly, the present invention relates to a work-in-process inspection system for determining whether a reference working process is performed by comparing a working motion to a reference motion, using real time vision, in an assembly process.

2. Discussion of the Related Art

When a worker manually assembles a part in an assembly process for a vehicle, an exact assembly process is important. For example, a piston is assembled within a cylinder block, and an oil ring and a piston ring are joined to the piston to avoid oil leakage. The piston ring and the oil ring are each formed in a ring shape that is partially open. When the piston ring and the oil ring are joined to the piston, the open portions of the piston ring and the oil ring should be oriented opposite one another to prevent oil leakage.

When the relative assembly directions of the open portion of the piston ring and the oil ring are changed, engine oil may leak and engine output may be deteriorated. In addition, a connecting rod is rotatably assembled to the piston. Whether the connecting rod is smoothly rotatable during the assembly process must be manually determined. When such a rotation status of the connecting rod is not checked, substantially high heat is generated by friction during high speed rotation of the engine, which may damage the engine. When assembling various parts of a vehicle as described above, various problems with the vehicle and engine may arise later due to poor assembly, when an assembly process of different parts is not checked manually. The foregoing is intended merely to aid in the understanding of the background of the present invention, and is not intended to mean that the present invention falls within the purview of the related art that is already known to those skilled in the art.

### SUMMARY

The present invention provides a work-in-process inspection system using motion detection to determine a predetermined process sequence or process status. Such a system may include a moving image imaging device configured to capture images of a working motion of a worker; an imaging device configured to capture an image of a vehicle part that is operated upon; and a controller configured to determine a difference between the working motion of the worker captured by the moving image imaging device and a predetermined reference motion, and determining a difference between the image captured by the imaging device and a predetermined reference image.

The controller may include a motion extractor configured to extract a joint motion from the working motion by the moving image imaging device; a motion determiner configured to determine a difference between the joint motion extracted by the motion extractor and a predetermined reference motion; and an image determiner configured to determine a difference between the image captured by the imaging device and a predetermined reference image. The work-in-process inspection system may further include a warning unit operated by the controller to generate an alarm, when the difference between the joint motion extracted by the motion extractor and the predetermined reference motion exceeds a predetermined first level, or when the difference between the image captured by the imaging device and the predetermined reference image exceeds a predetermined second level.

The work-in-process inspection system may further include an infrared wavelength band imaging device (infrared image imaging device). The controller may further include a body extractor configured to extract a working region of the worker from the image captured by the infrared imaging device, and the motion extractor is configured to extract the joint motion of the worker in the extracted working region. The controller may further be configured to determine whether a reference working process is performed during a retention time during which the working motion of the worker image is captured (e.g., the working motion is detected) by the moving image imaging device, and remains within a predetermined virtual working region.

Further, the controller may include a region determiner configured to determine the retention time, which may be defined as the length of time that the joint motion, extracted from the motion extractor, remains within the predetermined virtual working region. The retention time may be calculated from an entering time, which may be defined by the time that the joint motion extracted from the motion extractor enters the virtual working region until an exit time, which may be defined by the time that the joint motion exits (e.g., moves out of) the virtual working region. The region determiner may be configured to determine that the reference working process has been performed when the retention time is within a range of a predetermined reference time. The work-in-process inspection system may further include a warning unit configured to generate an alarm when the retention time is different from the predetermined reference time by a threshold amount.

A work-in-process inspection method according to another exemplary embodiment of the present invention may include capturing an image, by an imaging device, of a working motion of a worker; extracting a joint motion of the worker, by a motion extractor, from the working motion of the worker; comparing, by a controller, the extracted joint motion to a predetermined reference motion; capturing an image, by an imaging device, of a vehicle part that is operated on; and comparing, by the controller, the image to a reference image.

The work-in-process inspection method may further include generating an alarm, by the controller, when the difference between the joint motion extracted by the motion extractor and the predetermined reference motion exceeds a predetermined first level. In addition, the method may include generating an alarm, by the controller, when the difference between the image captured by the imaging device and the predetermined reference image exceeds a predetermined second level.

The work-in-process inspection method may further include capturing, using an infrared imaging device, an infrared body image in infrared wavelength band; extracting, by a body extractor, operated by the controller, a working region of a worker from the infrared body image, and extracting, by a motion extractor, operated by the controller, a joint motion of the worker from the working region. In addition, the method may include measuring, by the controller, a retention time, wherein the retention time is the length of time the extracted joint motion remains in a predetermined virtual working region; and determining, by the controller, whether a reference working process is performed by comparing the retention time with a range of a predetermined reference time.

The retention time may be defined by the time elapsed between an entering time, defined by the time that the joint motion extracted from the motion extractor enters the virtual working region until an exit time, defined by the time that the joint motion exits the virtual working region. The method may include determining, by the controller, that a reference working process is performed when the retention time is within a range of a predetermined reference time. The work-in-process inspection method may further include generating an alarm, by the controller, when the retention time is different from the predetermined reference time by a threshold amount.

### BRIEF DESCRIPTION OF THE DRAWINGS

The drawings are provided for reference in describing exemplary embodiments of the present invention, and the spirit of the present invention should not be construed only by the accompanying drawings. The above and other objects, features and other advantages of the present invention will be more clearly understood from the following detailed description when taken in conjunction with the accompanying drawings, in which:

FIG. 1 is an exemplary view illustrating a work-in-process inspection system according to an exemplary embodiment of the present invention;

FIG. 2 is an exemplary block diagram illustrating a work-in-process inspection system according to an exemplary embodiment of the present invention;

FIGS. 3A-3B are exemplary views for explaining a motion of a worker by using a work-in-process inspection system according to an exemplary embodiment of the present invention;

FIGS. 4A-4B are exemplary views illustrating a motion of a worker by using a work-in-process inspection system according to an exemplary embodiment of the present invention;

FIG. 5 is an exemplary view illustrating a work-in-process inspection system according to an exemplary embodiment of the present invention;

FIG. 6 is an exemplary view illustrating a motion of a worker using a work-in-process inspection system according to an exemplary embodiment of the present invention; and

FIG. 7 is an exemplary flowchart illustrating a work-in-process inspection method according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

As those skilled in the art would realize, the described exemplary embodiments may be modified in various different ways, all without departing from the spirit or scope of the present invention. In describing the present invention, parts that are not related to the description will be omitted. Like reference numerals generally designate like elements throughout the specification. In addition, the size and thickness of each configuration shown in the drawings are arbitrarily shown for better understanding and ease of description, but the present invention is not limited thereto. In the drawings, the thickness of layers, films, panels, regions, etc., are exaggerated for clarity.

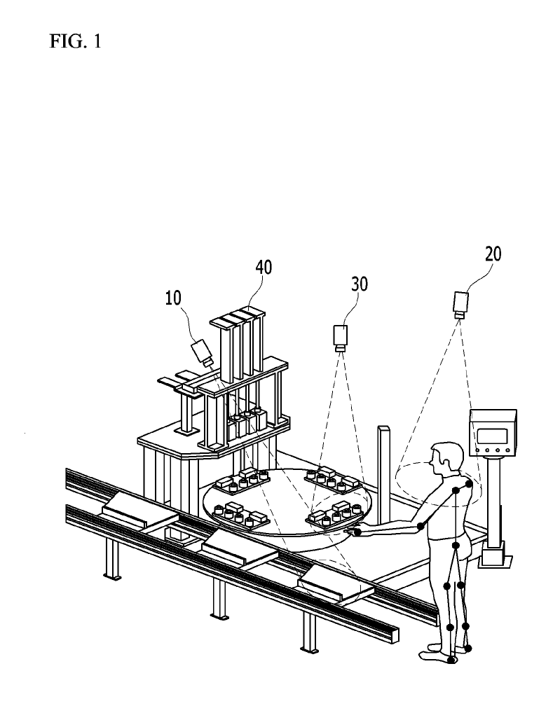

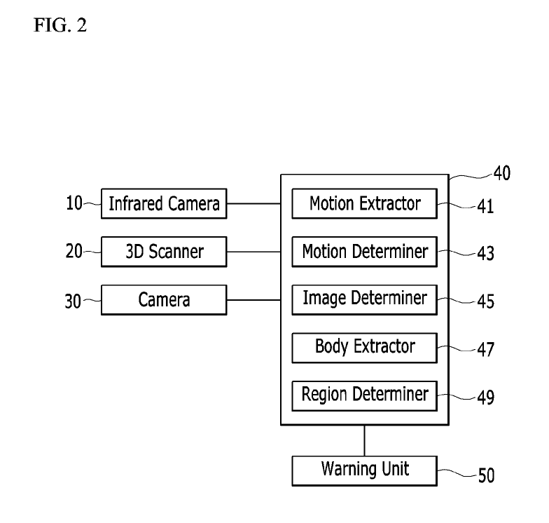

FIG. 1 is an exemplary schematic view illustrating a work-in-process inspection system according to an exemplary embodiment of the present invention, and FIG. 2 is an exemplary block diagram illustrating a work-in-process inspection system according to an exemplary embodiment of the present invention.

As shown in FIG. 1 and FIG. 2, an exemplary work-in-process inspection system may include: a moving image imaging device 20 configured to capture a moving image of a working motion of a worker, an imaging device 30 configured to capture an image of a vehicle part that is operated on, and a controller 40 configured to determine whether a reference process is performed using an image captured by the moving image imaging device 20 and the imaging device 30.

The moving image imaging device 20 may be a three-dimensional (3D) scanner, and the imaging device 20 may simply be a camera, video camera or the like, configured to capture an image, however other similar devices are within the scope of the invention.

The 3D scanner 20 may be configured to capture an image of the working motion of the worker, convert the working motion to three-dimensional data, and transmit the three-dimensional data to the controller 40. Basic operation of the 3D scanner 20 is widely known in the art, thus a more detailed description thereof will not be presented in the present specification. The imaging device 30 may be configured to capture an image (e.g., to photograph) parts that are operated on by the worker. An image captured by the imaging device 30 may be transmitted to the controller 40.

The controller 40 may include a motion extractor 41 configured to extract a joint motion of the worker, a motion determiner 43 configured to determine whether a reference process is performed by using information extracted by the motion extractor 41, and an image determiner 45 configured to determine whether the parts that are operated on by the worker satisfy a reference process status. The controller 40 may include at least one microprocessor configured to execute at least one computer program and includes hardware such as at least one microprocessor. The computer program may include a series of commands which cause exemplary systems of the present invention to perform a work-in-process inspection method according to an exemplary embodiment of the present invention, which will be described below.

The motion extractor 41 may be configured to extract joint information of the worker using three-dimensional data transmitted from the 3D scanner 20, and extract a joint motion of the worker using the joint information. It should be understood that joint information and joint motion relate to body parts of the worker and their motion and location; such body parts may include, but are not limited to the worker's wrists, fingers, elbows, shoulders, arms, hands, etc. The motion determiner 43 may be configured to compare the joint motion of the worker extracted by the motion extractor 41 to a predetermined reference motion, and determine whether the joint motion of the worker differs from the reference motion. In particular, the reference motion means a predetermined working sequence or a predetermined working process performed to accomplish specific work.

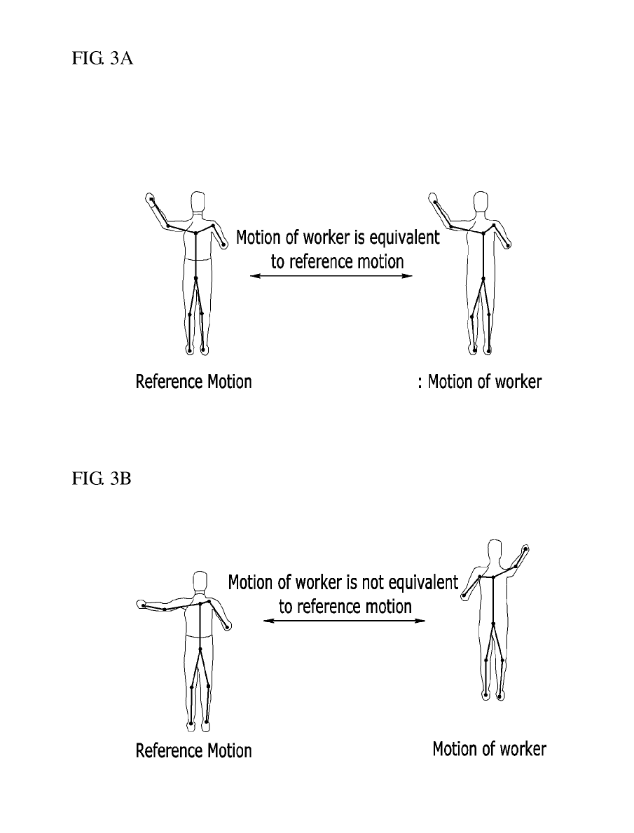

As shown in FIGS. 3A-3B, when the joint motion extracted by the motion extractor 41 is about the same as the reference motion (refer to FIG. 3A), the motion determiner 43 may be configured to determine whether a reference working process is performed. However, when the joint motion extracted by the motion extractor 41 differs from the reference motion (refer to FIG. 3B), the motion determiner 43 may be configured to determine that the reference working process is not performed. There may be a threshold amount of common movement between the reference motion and the extracted joint motion. Different tasks, (e.g., assembly tasks) may be associated with different thresholds without deviating from the spirit of the invention.

The image determiner 45 may be configured to compare an image captured by the imaging device 30 to a reference image, and determine whether the image captured by the imaging device 30 differs from the reference image. The reference image means an image of a predetermined working result used to determine whether a specific working process is performed. The image determiner 45 may be configured to compare the image of the part that is operated on to the reference image, thus it may be possible to determine that the worker performs predetermined work.

Further, the work-in-process inspection system according to an exemplary embodiment of the present invention may include an infrared imaging device 10 configured to capture a body image in an infrared wavelength band. The controller 40 may further include a body extractor 47 configured to extract a working region of the worker from the image captured by the infrared imaging device 10.

The infrared imaging device 10 may be configured to capture an infrared image in an 8-14 micrometer wavelength band. Visible light may be blocked by the infrared imaging device 10, and infrared light emitted from a human body may be visualized. Therefore, more precise working motion of the worker may be obtained. The body extractor 47 may be configured to extract a working region of the worker from a background image using the infrared wavelength band emitted from the worker. Accordingly, the working motion may be extracted in the working region extracted by the body extractor, thus the image determiner 45 may reduce an amount of time required for image processing. Further, the image determiner 45 may be configured to determine the working motion of the worker in the working region, thus the working motion may be interfered with due to a motion of a machine and the like and more precise working motion of the worker may be extracted.

Exemplary embodiments of the present invention may further include a warning unit 50, operated by the controller, to generate an alarm when the worker does not perform a predetermined working process at least sufficiently, or when the part that is operated on does not satisfy a predetermined working status. In other words, the warning unit 50 may be configured to generate an alarm when the extracted joint motion, extracted by the motion determiner 43, differs from the predetermined reference motion by at least a threshold amount. The warning unit 50 may include various devices, including, but not limited to a siren, a buzzer, a light bar or the like.

An exemplary assembly process for a connecting rod 93 that is rotatably assembled with a piston 91 will be described herein below, in detail. When the connecting rod 93 is assembled to a piston 91, an oil ring 95 for preventing oil leakage may be assembled to the piston 91, the connecting rod 93 may be assembled to the piston 91 via a hinge, and whether the connecting rod 93 rotates smoothly may be determined. the controller may be configured to determine a rotation status of the connecting rod 93 assembled to the piston 91 from analyzing the joint motion of the worker.

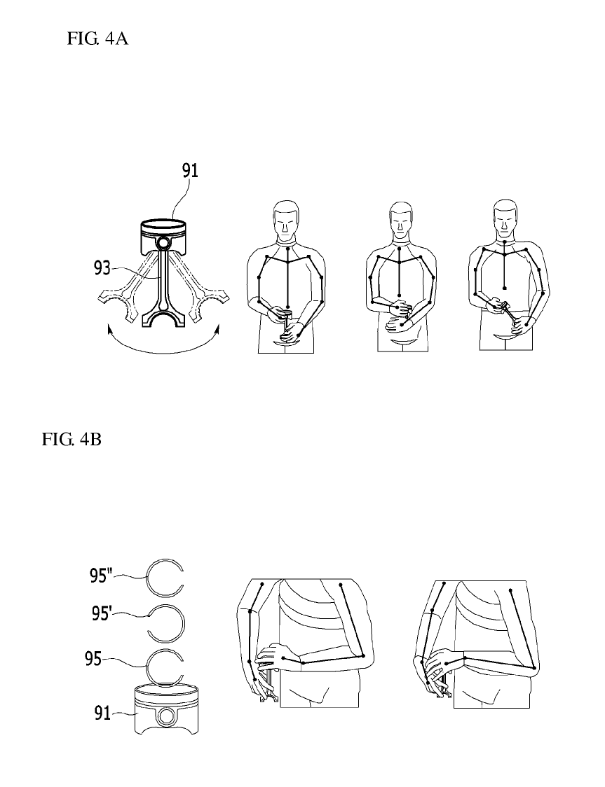

As shown in FIG. 4A, the controller 40 may be configured to extract a joint motion of the worker from an image obtained by the 3D scanner 20. The controller 40 may be configured to determine whether an operation of swinging the connecting rod 93 in left and right directions is performed, by analyzing the joint motion of the worker. As shown in FIG. 4B, the controller 40 may be configured to determine whether the oil ring 95 is assembled to the piston 91 by analyzing the joint motion of the worker obtained by the 3D scanner 20. Accordingly, the controller 40 may be configured to determine the joint motion of the worker using the 3D scanner 20, thus the controller 40 may be configured to determine whether a predetermined working process is performed.

When the predetermined working process is not performed, the controller 40 may be configured to operate the warning unit 50 to generate an alarm that indicates that the worker has not performed the predetermined working process and the worker may correct the deficiency. Therefore, an assembly defect may be prevented.

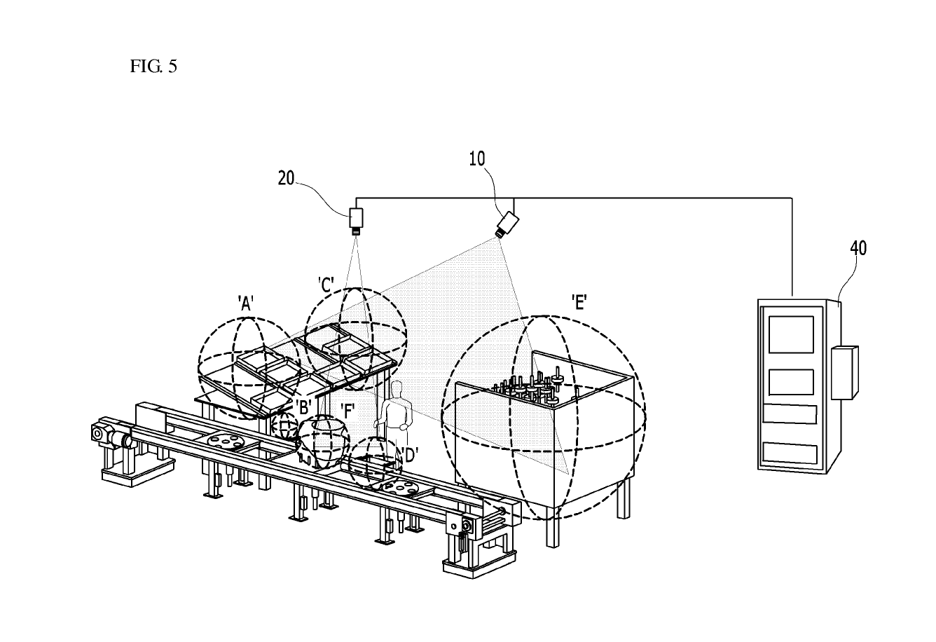

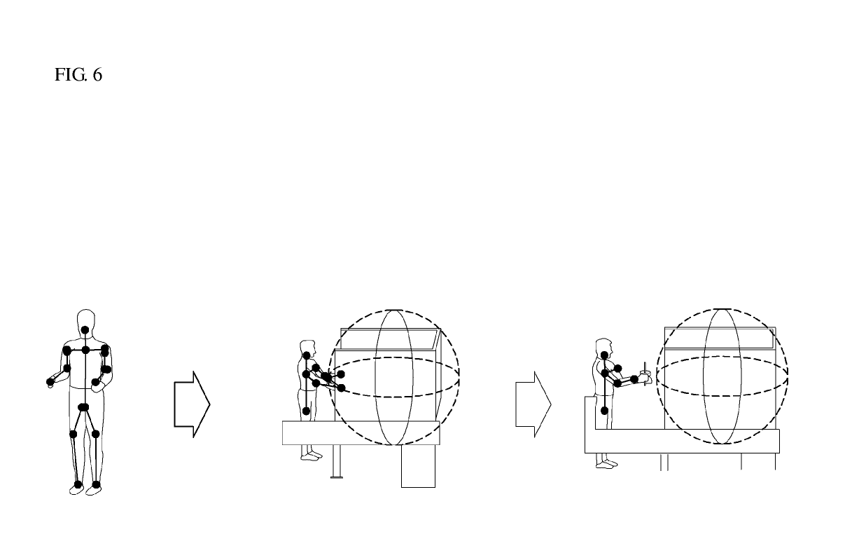

Hereinafter, a work-in-process inspection system according to another exemplary embodiment of the present invention will be described in detail with reference to the accompanying drawings. FIG. 5 is an exemplary schematic view illustrating a work-in-process inspection system according to another exemplary embodiment of the present invention; and FIG. 6 is an exemplary schematic view illustrating a motion of a worker using a work-in-process inspection system according to an exemplary embodiment of the present invention. The work-in-process inspection system may set a virtual working region and determine whether the reference working process is performed from a retention time that the worker remains in the virtual working region. Thus, the controller 40 may further include a region determiner 49 configured to determine whether the reference working process is performed from a working motion of the worker extracted by the motion extractor 41.

The region determiner 49 may be configured to determine whether the joint motion of the worker extracted by the motion extractor 41 remains in a predetermined virtual working region for a predetermined time, and determine whether the reference working process is performed. A staying time in the predetermined virtual working region for a predetermined time may be defined as a retention time, as described above.

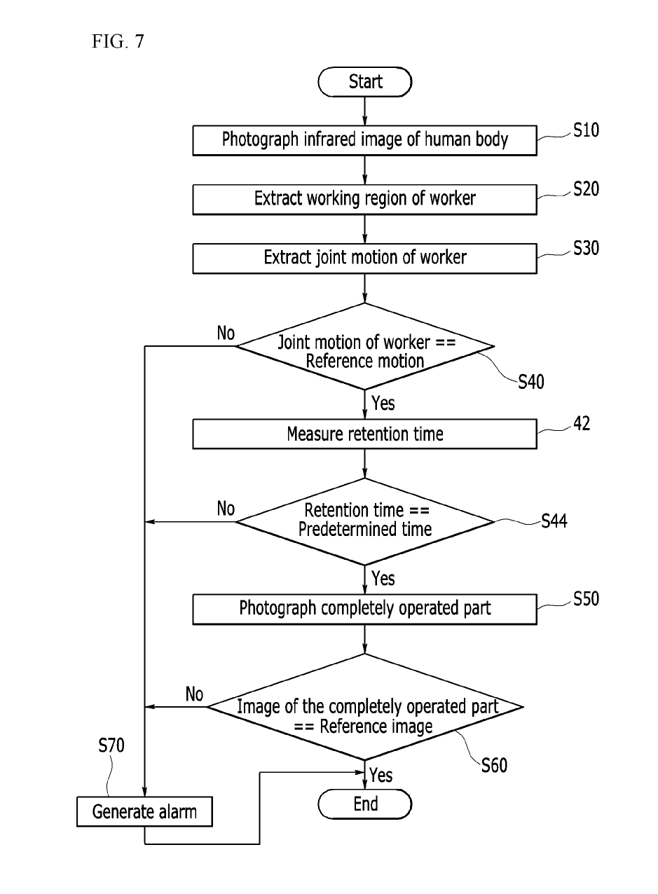

As shown in FIG. 7, the motion extractor 41 may be configured to extract a joint position and a joint motion of the worker using 3-dimensional data, and the region determiner 49 may be configured to measure an entering time that the joint motion enters the predetermined virtual working region and an exit time that the joint motion exits the predetermined virtual working region. The region determiner 49 may be configured to calculate the retention time from the entering time and the exit time. The region determiner 49 may be configured to determine that the reference working process is performed when the joint motion remains in the virtual working region within an error range of the predetermined time, e.g., the error range may be within less than 1%, to 5% to 50%, or more, of the predetermined time and the error range may be different for different types of assembly tasks performed by a worker. The region determiner 4 may be configured to determine that the reference working process has not been performed when the retention time is beyond the error range of the predetermined time, that is the retention time exceeds or is less than the reference time by greater than the error range, noting that the error range for time exceeding the reference time may not be the same as the error range for time less than the reference time.

An assembly process of a transmission, according to an exemplary method of the present invention will be described in detail. A hub, a thrust washer, a hub assembly, a thrust bearing and a hub clutch should be sequentially assembled to the transmission. As shown in FIG. 5, a virtual working region may be set based on a worktable which provides various parts. For example, a neighboring area of the work table holding the hub may be set as ‘A’ region of the virtual working region, a neighboring area of the worktable holding the thrust washer may be set as ‘B’ region of the virtual working region, a neighboring area of the worktable holding the hub assembly may be set as ‘C’ region of the virtual working region, a neighboring area of the worktable holding the thrust bearing may be set as ‘D’ region of the virtual working region, and a neighboring area of the worktable holding the hub clutch may be set as ‘E’ region of the virtual working region, and a neighboring area of the worktable for assembling the various parts may be set as ‘F’ region of the virtual working region.

The motion extractor 41 may be configured to extract the joint position and the joint motion of the worker using the 3D scanner 10. The region determiner 49 may be configured to measure an entering time that the joint motion extracted by the motion extractor 41 enters the ‘A’ region and an exit time that the joint motion exits from the ‘A’ region. In addition, the region determiner 43 may be configured to calculate a retention time that the joint motion remains in the ‘A’ region. When the retention time in the ‘A’ region is about the same as a predetermined time, or time range, the region determiner 49 may be configured to determine that the hub in the ‘A’ region has been picked up.

The region determiner 49 may be configured to measure a retention time of the ‘F’ region after the predetermined time of the ‘A’ region. When the retention time in the ‘F’ region is about the same as a predetermined time, the region determiner 4 may be configured to determine that the the hub in the ‘F’ region has been assembled. The region determiner 49 may be configured to measure an entering time that the joint motion extracted by the motion extractor 41 enters the ‘B’ region and an exit time that the joint motion exits from the ‘B’ region. Further, the region determiner 49 may be configured to calculate a retention time that the joint motion remains in the ‘B’ region. When the retention time in the ‘B’ region is about the same as a predetermined time, the region determiner 49 may be configured to determine that the thrust washer in the ‘B’ region has been picked up.

The region determiner 49 may be configured to determine a retention time of the ‘F’ region after the predetermined time of the ‘B’ region. If the retention time in the ‘F’ region is the same, or nearly the same, as a predetermined time, the region determiner 49 may be configured to determine that the thrust washer in the ‘F’ region has been assembled. The region determiner 49 may be configured to measure an entering time that the joint motion extracted by the motion extractor 41 enters the ‘C’ region and an exit time that the joint motion exits from the ‘C’ region. The region determiner 49 may be configured to calculate a retention time that the joint motion remains in the ‘C’ region. When the retention time in the ‘C’ region is about the same as a predetermined time, the region determiner 49 may be configured to determine that the hub assembly in the ‘C’ region has been picked up.

The region determiner 49 may be configured to measure a retention time of the ‘F’ region after the predetermined time of the ‘C’ region. When the retention time in the ‘F’ region is about the same as a predetermined time, the region determiner 49 may determine that the hub assembly in the ‘F’ region has been assembled. The region determiner 49 may be configured to measure an entering time that the joint motion extracted by the motion extractor 41 enters the ‘D’ region and an exit time that the joint motion exits from the ‘D’ region. And the region determiner 49 may be configured to calculate a retention time that the joint motion remains in the ‘D’ region. When the retention time in the ‘D’ region is about the same as a predetermined time, the region determiner 49 may be configured to determine that the thrust bearing in the ‘D’ region has been picked up. The region determiner 49 may be configured to measure a retention time of the ‘F’ region after the predetermined time of the ‘D’ region. When the retention time in the ‘F’ region is about the same as a predetermined time, the region determiner 49 may be configured to determine that the thrust bearing in the ‘F’ region has been picked up. The region determiner 49 may be configured to measure an entering time that the joint motion extracted by the motion extractor 41 enters the ‘E’ region and an exit time that the joint motion exits from the ‘E’ region.

Further, the region determiner 49 may be configured to calculate a retention time that the joint motion remains in the ‘E’ region. If the retention time of the ‘E’ region is about the same as a predetermined time, the region determiner 49 may be configured to determine that the hub clutch in the ‘E’ region has been picked dup. The region determiner 49 may be configured to measure a retention time of the ‘F’ region after the predetermined time of the ‘E’ region. When the retention time in the ‘F’ region is about the same as a predetermined time, the region determiner 49 may be configured to determine that the hub clutch in the ‘F’ region has been assembled.

As described above, according to an exemplary embodiment of the present invention, whether the worker performs a series of working process may be determined by measuring the retention time of each region. Meanwhile, the warning unit 50 may be configured to generate an alarm when the retention time calculated by the region determiner 49 is different from, or sufficiently different from, a predetermined time, or the retention time is out of an error range of the predetermined time.

Hereinafter, a work-in-process inspection method according to an exemplary embodiment of the present invention will be described in detail with reference to FIG. 7. FIG. 7 is an exemplary flowchart illustrating a work-in-process inspection method according to an exemplary embodiment of the present invention. As shown in FIG. 7, a body image of the worker may be captured by an infrared imaging device 10 (S10). The body extractor of the controller 40 may be configured to extract a working region of the worker from the body image captured by the infrared imaging device 10 (S20).

The working motion of the worker may be captured by the 3D scanner 20 and the working motion of the worker captured by the 3D scanner 20 may be transmitted to the controller 40. Then, the motion extractor 41 of the controller 40 may be configured to extract a joint motion of the worker in the working region (S30). Accordingly, since the joint motion of the worker may be extracted in the working region, a time and calculation amount for extracting the joint motion may be reduced. Further, since interference by a motion of a machine excluding the worker is reduced or minimized, the joint motion of the worker may be more precisely extracted. The controller 40 may be configured to determine whether the joint motion differs from a predetermined reference motion, and may be configured to determine whether the worker performs the predetermined working process (S40).

When the joint motion differs sufficiently from the reference motion, an alarm may be generated by the warning unit 50 so that the worker performs the reference working process, (S70). After the worker performs the reference working process, the imaging device 30 may be configured to capture an image of the part, (e.g., a vehicle part) that is operated on (S50). The controller 40 may be configured to compare an image captured by the imaging device 30 to a predetermined reference image, and determine whether assembly of the part that is operated on by the worker is performed (S60).

When the image captured by the imaging device differs from the reference image, an alarm that indicates that a defect has occurred in the part that is operated on, may be generated by the warning unit 50 (S70) and the worker may remedy the deficiency. Accordingly, assembly defects may be prevented by comparing the image captured by the imaging device 30 to the reference image. Meanwhile, the region determiner 49 may be configured to measure a retention time that the extracted joint motion remains in a predetermined virtual working region (S42). The region determiner 49 may be configured to determine whether the measured retention time is about the same as a predetermined time (S44). When the measured retention time is sufficiently different from the predetermined time, an alarm may be generated by the warning unit 50 to allow the worker to correctly perform the reference working process, (S70).

According to an exemplary embodiment of the present invention, it may be possible to determine whether a worker performs a predetermined working process by comparing a moving image captured using a 3D scanner to a reference motion. Further, it may be possible to determine whether a process status of a worker satisfies a predetermined process status. In addition, since a working motion of a worker may be extracted in a working region of the worker, the working motion is extracted.

Further, it may be possible to determine whether a worker performs a predetermined working process from a measured retention time that a working motion of the worker remains in a predetermined virtual working region for a predetermined time.

### DESCRIPTION OF SYMBOLS

10: infrared imaging device
20: 3D scanner
30: imaging device
40: controller
41: motion extractor
43: motion determiner
45: image determiner
47: body extractor
49: region determiner
50: warning unit

While this invention has been described in connection with what is presently considered to be exemplary embodiments, it is to be understood that the invention is not limited to the disclosed exemplary embodiments, but, on the contrary, is intended to cover various modifications and equivalent arrangements included within the spirit and scope of the appended claims.

What is claimed is:

1. A work-in-process inspection system comprising:
a moving image imaging device configured to capture a working motion of a worker;
an imaging device configured to capture an image of a part that is operated on; and
a controller configured to determine a difference between the working motion of the worker captured by the moving image imaging device and a predetermined reference motion, and determine a difference between the image captured by the imaging device and a predetermined reference image.

2. The work-in-process inspection system of claim 1, wherein the controller is further configured to extract a joint motion from the working motion by the moving image imaging device;
determine a difference between the extracted joint motion and a predetermined reference motion; and
determine a difference between the image captured by the imaging device and a predetermined reference image.

3. The work-in-process inspection system of claim 2, wherein the controller is further configured to generate an alarm when a difference between the extracted joint motion and the predetermined reference motion exceeds a predetermined first level, or when a difference between the image captured by the imaging device and the reference image exceeds a predetermined second level.

4. The work-in-process inspection system of claim 1, further comprising:
an infrared capture device configured to capture an infrared body image in an infrared wavelength band,
wherein the controller is configured to extract a working region of the worker from the image captured by the infrared capture device, and extract a joint motion of the worker in the extracted working region.

5. The work-in-process inspection system of claim 1,
wherein the controller is configured to determine whether a reference working process is performed from a retention time that the working motion of the worker captured by the moving image imaging device remains in a predetermined virtual working region.

6. The work-in-process inspection system of claim 5, wherein the controller is configured to determine the retention time that the extracted joint motion remains in the predetermined virtual working region.

7. The work-in-process inspection system of claim 6, wherein the retention time is measured from an entering time that the joint motion extracted from the motion extractor enters the virtual working region until an exit time that the joint motion exits the virtual working region.

8. The work-in-process inspection system of claim 6, wherein the controller is configured to determine that the worker performs the reference working process when the retention time is within a range of a predetermined reference time.

9. The work-in-process inspection system of claim 6, wherein the controller is configured to generate an alarm when the retention time is different from the predetermined reference time by a threshold amount.

10. The work-in-process inspection system of claim 2, wherein the controller is configured to determine whether a reference working process is performed from a retention time that the working motion of the worker captured by the moving image imaging device remains in a predetermined virtual working region.

11. The work-in-process inspection system of claim 10, wherein the controller is configured to determine the retention time that the extracted joint motion remains in the predetermined virtual working region.

12. The work-in-process inspection system of claim 11, wherein the retention time is measured from an entering time that the joint motion extracted from the motion extractor enters the virtual working region until an escaping time that the joint motion exits the virtual working region.

13. The work-in-process inspection system of claim 11, wherein the controller is configured to determine that the worker performs the reference working process when the retention time is within a range of a predetermined reference time.

14. The work-in-process inspection system of claim 11, wherein the controller is configured to generate an alarm when the retention time is different from the predetermined reference time by a threshold amount.

15. A work-in-process inspection method, comprising:
capturing, by a moving image imaging device, an image of a working motion of a worker;
extracting, by a controller, a joint motion of the worker from the working motion of the worker;
comparing, by the controller, the extracted joint motion to a predetermined reference motion;
capturing an image, by an imaging device, a part that is operated on; and
comparing, by the controller, the image to a reference image.

16. The work-in-process inspection method of claim 15, further comprising:
generating, by the controller, an alarm in response to a difference between the joint motion extracted by the motion extractor and a predetermined reference motion is exceeds a predetermined first level.

17. The work-in-process inspection method of claim 15, further comprising:
generating, by the controller, an alarm when the difference between the image captured by the imaging device and the predetermined reference image exceeds a predetermined second level.

18. The work-in-process inspection method of claim 15, further comprising:
capturing an infrared image, by an infrared imaging device, a body image in an infrared wavelength band;
extracting, by the controller, a working region of a worker from the infrared image, and
extracting a joint motion, by a motion extractor, of the worker from the working region.

19. The work-in-process inspection method of claim 15, further comprising:
measuring, by the controller, a retention time that the extracted joint motion remains in a predetermined virtual working region; and
determining, by the controller, whether a reference working process is performed by comparing the retention time with a predetermined reference time.

20. The work-in-process inspection method of claim 19, wherein the retention time is measured from an entering time that the joint motion extracted from the motion extractor enters the virtual working region until an exit time that the joint motion exits the virtual working region.

21. The work-in-process inspection method of claim 19, further comprising:
determining, by the controller, that the reference working process is performed when the retention time is within a range of the predetermined reference time.

22. The work-in-process inspection method of claim 19, further comprising
generating alarm when the retention time is different from the predetermined time.
